(19) United States
(12) Patent Application Publication
(10) Pub. No.: US 2008/0068992 A1
(43) Pub. Date: Mar. 20, 2008

(54) Method and Device for Shaping Traffic Flow Transmitted in Network

(76) Inventors: Weiping Xie, Guangdong (CN); Haijun Wu, Guangdong (CN)

Correspondence Address: LADAS & PARRY LLP, 224 SOUTH MICHIGAN AVENUE, SUITE 1600, CHICAGO, IL, 60604, US

(21) Appl. No.: 11/597,467

(22) PCT Filed: May 17, 2006
(86) PCT No.: PCT/CN06/01010

§ 371 Date: May 8, 2007

(30) Foreign Application Priority Data
May 17, 2005 (CN) 200510070612.9

(51) Int. Cl. G08C 15/04

(52) U.S. Cl. 370/230

(57) ABSTRACT

A method and device for shaping the traffic flow transmitted in the network. The method mainly includes: after the traffic flow (TF) sent from the video source server is received, scheduling and shaping the TF respectively according to the type of the received TF, and sending the shaped TF to an access device. As a result of this invention, it is possible to prevent the influence to the access device from the video flow burst in the development of the present IP television (IPTV) service so as to ensure the reliability of the access device in the network. This invention also has such advantages as simple implementation process and low cost.

### FIELD OF THE INVENTION

The present invention relates to the network communication technology, particularly to a method and a device for shaping traffic flow transmitted in a network.

### BACKGROUND OF THE INVENTION

Along with rapid development of the network technology, network communication services have been abundant. At present, operators are preparing for a large-scale building for IP television (IPTV). As the IPTV is relative to a whole network solution and characterized in a larger amount of network flow with certain burstness, and all levels of equipments in the existing network lack a comprehensive consideration in the processing of the burst flow, the IPTV service meets quite a lot of difficulties at its initial development stage.

Now the most difficult problem is that the access device is influenced by the burst flow. The access device generally refers to the Digital Subscriber Line Access Multiplexer (DSLAM) equipment.

Because a simple Personal Computer (PC) or a server with a limited processing capacity is used as a TV video source server by many operators, when video source is encoded by the TV video source server, the flow can not be uniformly processed which results in that when the TV video source is sent from the TV video source server after being encoded, data flow sent from the TV video source server has a high burstness; the data flow with a high burstness will be sent to a access device via a convergent network and then forwarded by the access device to a customer premises equipment (CPE).

In an existing communication network, the convergent equipment generally has a higher buffer capacity, so it allows of a high burstness of the IPTV service; however, the access device can not allow of a high burstness of the IPTV service. If a message is dropped for that the access device can not bear the burstness of the data flow, there appears such phenomena as a blurred screen or mosaic, then the IPTV service can not be developed normally and the boost of the IPTV service is badly affected.

### SUMMARY OF THE INVENTION

The invention provides the following technical proposals.

A method for shaping the TF transmitted in a network includes the following steps:

a TF sent from a video source server is received; the TF is scheduled and shaped according to the set rules, and the TF is sent to an access device.

A device for shaping the TF transmitted in the network includes a receiving interface module, a scheduling and shaping module and a sending interface module,

the receiving interface module is for receiving and buffering the TF sent from a video source server, and sending the descriptive information of the TF to the scheduling and shaping module;

the scheduling and shaping module is for scheduling and shaping the TF according to the descriptive information received and set rules, and sending the descriptive information of the scheduled and shaped TF to the sending interface module;

the sending interface module is for receiving the descriptive information of the scheduled and shaped TF from the scheduling and shaping module, and reading out the TF from the buffer according to the descriptive information of the scheduled and shaped TF and sending it.

It can be seen from the technical proposal provided by aforesaid present invention that problem can be effectively resolved by putting the invention into practice so as to ensure the reliability of the access device in the network.

The invention also has such advantages as simple implement process and a low cost, so for the operators, it is only needs a low cost to prevent the access device from being affected by the video flow.

### BRIEF DESCRIPTION OF THE DRAWINGS

FIG. 1 is an exemplary flow chart illustrating the method according to an embodiment of this invention.

FIG. 2 is an exemplary schematic illustrating the structure of the device according to an embodiment of this invention.

FIG. 3 is an exemplary schematic illustrating the structure of the scheduling and shaping module in FIG. 2.

### DETAILED DESCRIPTION OF PREFERRED EMBODIMENTS

This invention is hereinafter described in detail with reference to the embodiments and the accompanying drawings.

According to embodiments of the invention, the traffic flow (TF) sent from the video server is scheduled and shaped and then sent to an access device so that a large quantity of TF will no longer be suddenly received by the access device.

In a specific embodiment of the invention, it is possible to provide a corresponding scheduling and shaping function at any position on the TF transfer path between the video server and the access device for scheduling and shaping the burst TF; for example, the scheduling and shaping function may be configured at an outlet of a video server or inlet of an access device for shaping the video data flow so as to eliminate the influence of the data flow burst on the access device, thereby solving the problems occurred in the IPTV service development.

In the embodiments of this invention, various modes can be used for the scheduling and shaping processing, such as buffering and equably sending, or classifiedly scheduling and sending according to preset rules after buffering.

An embodiment of the invention provides a method for shaping TF transmitted in the network which is mainly used to process the possible burst TF between the video server and access device with a scheduling and shaping treatment so as to prevent the access device from being badly influenced by the burst data.

In the method, at first it is necessary to set a global parameter T (shared by all flow classification queues) referring to a time cycle for shaping which can be set by a console; and it is also necessary to set a timer for timing which may be maintained by a shaping equipment itself.

It is necessary to set two local parameters (exclusively used by each flow classification queue) for each flow classification queue: one is the volume of TF allowed to be sent within time T, Flow_set, which may be the number of cells or the number of bytes, etc., and this parameter may be set via the console□ the other is the statistics of the volume of the TF sent in time T, Flow_current, which also may be the number of cells or the number of bytes, etc. corresponding to the Flow_set, this parameter is maintained by internal equipment and will be reset when the device initializes.

In the implementation process of the method according to the embodiment of the invention, at first, the received TF from the video server need buffering, and then the scheduling and shaping treatment is made according to preset rules, which includes the following steps: setting a time cycle T and a flow parameter Flow_set which determines the volume of the TF allowed to be sent within the time cycle T; controlling the TF sent within time T by making the statistic of volume of the TF having currently been sent, i.e, Flow_current, comparing the Flow_current with Flow_set and resetting the Flow_current according to time T. By implementing the above steps, the TF is shaped.

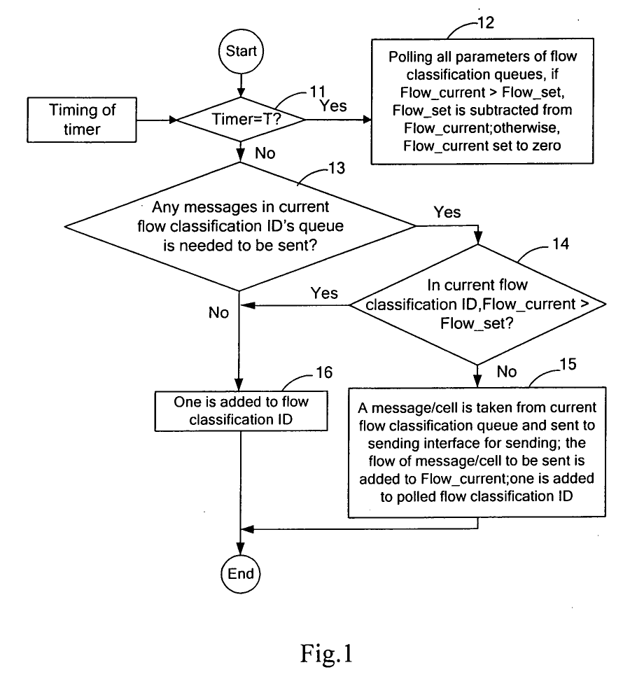

As shown in FIG. 1, the processing according to the method includes the following steps:

Step 11: start the timing of the timer and determine whether a preset time is reached, if the preset time is reached, proceed to step 12; otherwise, proceed to step 13;

Step 12: poll all TF queues, i.e. poll the flow classification queue parameter which is the volume of the TF having been sent in each queue; if the volume of the TF having been sent set by the current flow classification queue within the set period of time is larger than that allowed to be sent, the volume of the TF having been sent which is currently statistic is updated as the volume of the TF having really been sent minus the volume of that allowed to be sent; otherwise, the flow volume of the TF having been sent which is currently statistic is set as zero.

Step 13: determine whether the TF queue identified by the current TF, i.e. determine whether the queue of the current flow classification ID, has messages to be sent, if yes, proceed to step 14; otherwise, proceed to step 16;

Step 14: continue to determine, for the flow classification queue corresponding to the current flow classification ID, whether the volume of the TF having been sent in the queue of the current flow classification ID is larger than that allowed to be sent, if yes, proceed to step 16; otherwise, proceed to step 15;

Step 15: a message or a cell is taken from the current flow classification queue and sent to the sending interface for transmitting, and meanwhile the TF of the message or cell to be sent is added to the volume of the TF having been sent and the flow classification ID is added by one for scheduling and shaping the next flow classification queue and proceed to step 11;

Step 16: the flow classification ID is added by one, and proceed to step 11, i.e. schedule and send the next TF queue.

By a continual repeating execution of the aforesaid procedures, the shaping treatment of the data sent from the video server may be realized, so that the corresponding TF may be rather smoothly received by the access device and the bad influence of the video flow burst can be avoided.

Based on the method according to the embodiment of the invention aforesaid, an embodiment of the invention also provides a simplified device for shaping the TF transmitted in the network, i.e. a device or module based on shaping the TF. The device may be particularly placed at the outlet of the video server or the inlet of the access device for shaping TF, for example, multicast or VOD (video-on-demand) TF, and may get rid of the TF burst, reduce the demand for the access device, and ensure the development of such video services as IPTV.

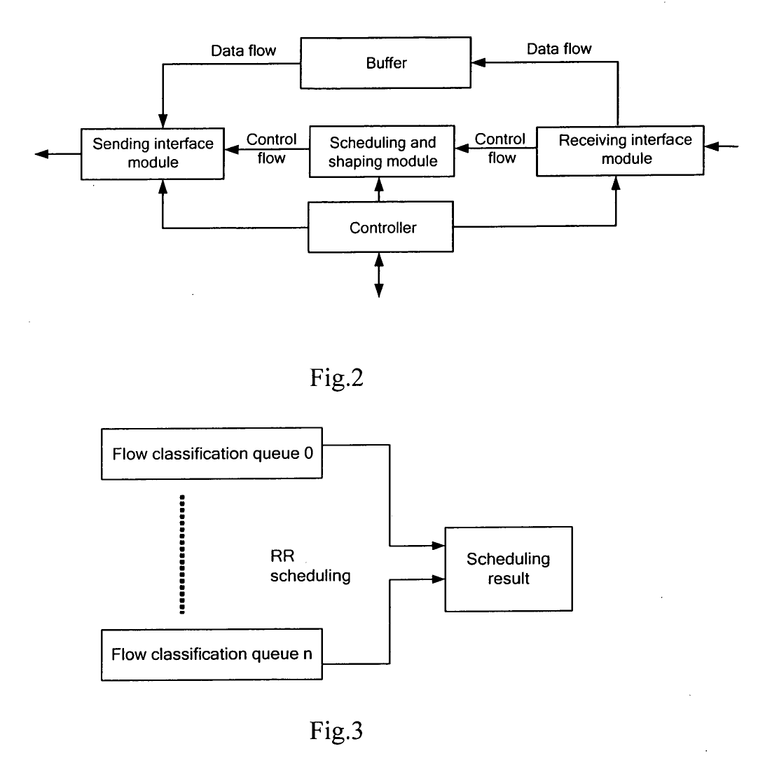

The detailed structure provided by an embodiment of the invention is hereinafter described; as shown in FIG. 2 and FIG. 3, the device preferably includes a receiving interface module, a scheduling and shaping module, a sending module and a controller, wherein:

(1) the receiving interface module is used to receive the data flow, and stores the data flow to a buffer according to a “first arrives, first processed” principle, and it is also necessary to transfer the descriptive information of the data flow to the scheduling and shaping module so as to perform a classified scheduling and shaping treatment to corresponding data flow according to the descriptive information;

the data flow includes but not be limited to an Ethernet frame, an ATM cell etc.;

(2) the scheduling and shaping module is used to classify the multicast video flow or VOD flow according to the descriptive information, and each data flow corresponds to a corresponding queue which stores the descriptive information of the data flow. As shown in FIG. 3, the descriptive information refers to characterized information different from other data, such as the place where the data flow (i.e. TF flow) is buffered in a buffer, the type information of the data flow, length information etc., the descriptive information may be the message's destination MAC address/source MAC address, source IP address/destination IP address etc. or the information carried in other fields of the data flow;

in this module, the actual TF in the buffer is scheduled and sent according to the descriptive information in each queue, and meanwhile a statistic on volume of the sent TF is obtained for scheduling and shaping the TF according to the statistical result in the subsequent scheduling and sending processing;

the number of various descriptive information queues of data flow particularly provided is determined according to the number of flow classification can be or need to be supported by the device;

in the module, it is necessary to schedule and shape the data flow according to the result of the flow classification, and send the descriptive information of data flow (i.e. classification result) to the sending interface module, and the sending interface module schedules and sends the data information of the corresponding data flow according to the descriptive information so as to realize the shaping and scheduling treatment of the data flow;

as shown in FIG. 3, an RR (round robin) scheduling method is used between flow classification queues, certainly it may be appreciated by those skilled in the art that other scheduling methods may also be used for the scheduling treatment, and there is no limitation for it in the embodiment of the present invention. As to the respective shaping treatment in each flow classification queue, the detailed scheduling treatment method is described in the method hereinbefore, so it is not described here in detail;

(3) the sending interface module is use to read out data flow from the buffer in light of the “first arrives, first processed” principle according to the descriptive information of the data flow transferred by the scheduling and shaping module, specifically, read out the data flow according with the descriptive information from the buffer in turn, and send the data flow;

(4) the controller is used for configuring the parameter information, that is the user configures the Flow_set parameter, time parameter T etc which are necessary for the scheduling and shaping module to perform a corresponding treatment.

The burst flow can be controlled within a certain range by setting the volume of the timing T parameter and the volume of TF allowed to be sent Flow_set parameter according to the embodiments of this invention so that the TF can certainly be processed by the access device. Furthermore this invention has been realized and verified in practice with a good influence.

The device according to the embodiment of the invention can be configured at the outlet of the video source server or the inlet of such access device as DSLAM to shape the TF. It is also possible to add a module into the existing access device as a single board or unit of the existing access device, i.e. built in the access device, for the shaping treatment of the TF received.

To sum up, the realization of this invention can possibly avoid the bad influence to the access device from the video flow burst in the development of the present IPTV service at a low cost so that the operator may smoothly develop the IPTV business, and it is possible for the equipment supplier to overcome the difficulty in rebuilding due to that the access device's performances can not meet the operation request.

The aforesaid are only preferred embodiments according to this invention rather than limitation of the scope of this invention. It should be noted that any alternations and modifications easily occurring to those skilled in the art within the technical scope disclosed by this invention shall fall into the protection scope of this invention as set by the appended claims and its equivalents.

1. A method for shaping the traffic flow (TF) transmitted in the network, comprising:
receiving a TF sent from a video source server;
scheduling and shaping the TF according to set rules; and
sending the shaped TF to an access device.

2. The method according to claim 1, wherein the step of scheduling and shaping the TF according to set rules comprises:
classifying the TF according to the types of the received TF; and
scheduling and shaping the TF according to the flow classification results.

3. The method according to claim 2, wherein the step of scheduling and shaping the TF according to the flow classification results comprises:
setting a volume of the TF allowed to be sent for each type of TF during a set period of time;
for the TF type being currently processed, making a statistic of the volume of the TF having been sent during the set period of time;
comparing the volume with the corresponding set volume of the TF allowed to be sent; and
scheduling and shaping the corresponding TF according to the result of comparison.

4. The method according to claim 3, wherein the step of setting a volume of the TF allowed to be sent for each type if TF further comprises:
before setting a volume of the TF allowed to be sent for each type of TF, respectively storing the classified TF into a corresponding TF queue in a buffer in turn, and setting a corresponding TF ID for each TF queue respectively; or
before setting a volume of the TF allowed to be sent for each type of TF, respectively storing the classified TF into a buffer in turn, at the same time respectively establishing a TF queue of the TF descriptive information for each type of the TF, setting a corresponding TF ID, and transferring the corresponding type of TF according to the TF descriptive information.

5. The method according to claim 4, wherein the step of classifying the received TF comprises: classifying the received TF according to the information in the messages of the received TF;
wherein the TF descriptive information comprises at least one of the following: position information of the TF stored in the buffer, information of each field in the TF message, length information of the TF message, a destination Media Access Control (MAC) address of the TF message, a source MAC address of the TF message, a source IP address of the TF message and a destination IP address of the TF message.

6. The method according to claim 4, wherein the TF ID adopts the corresponding serial number of each TF after an ordinal sorting.

7. The method according to claim 4, wherein the step of setting a volume of the allowed to be sent for each type of TF comprises:
setting the volume of the TF allowed to be sent in a set period of time for each type of TF respectively or setting the volume for all types of TF unitively.

8. The method according to claim 7, wherein the step of comparing the statistical volume with the corresponding set volume of the TF allowed to be sent and scheduling and shaping the corresponding TF according to the comparison making the statistic and the comparing and the scheduling and shaping and the sending steps comprises:
during the set period of time, determining whether the volume of the TF having been sent in the current TF queue is larger than that allowed to be sent, if the TF volume is larger than that allowed to be sent, polling the next TF queue according to the TF ID, and returning to the determining step; otherwise scheduling and sending and shaping the TF in the TF queue in turn.

9. The method according to any of claim 3, wherein the step of making a statistic of the volume of the TF having been sent during the set period of time for the TF type currently processed further comprises:
when the set time is over, making the statistic of the volume of the TF having been sent in each TF queue again, and restarting the timing.

10. The method according to claim 9, wherein the step of making the statistic of the volume of the TF having been sent in each TF queue again and restarting the timing comprises:
determining whether the volume of the TF having been sent in each TF queue exceeds that allowed to be sent; if the volume of the TF exceeds that allowed to be sent, updating the volume of the TF having currently been sent as the volume of the TF having currently been sent minus that allowed to be sent; otherwise, updating the volume of the TF having currently been sent as zero.

11. The method according claim 3, wherein the set period of time is a shaping cycle.

12. A device for shaping the traffic flow (TF) transmitted in the network comprising:
a receiving interface module, for receiving and buffering the TF sent from a video source server, and sending descriptive information of the TF to a scheduling and shaping module;
the scheduling and shaping module, for scheduling and shaping the TF according to the descriptive information received and set rules, and sending the descriptive information of the scheduled and shaped TF to a sending interface module;
the sending interface module, for receiving the descriptive information of the scheduled and shaped TF from the scheduling and shaping module, and getting out the TF from the buffer according to the descriptive information of the scheduled and shaped TF, and sending it.

13. The device according to claim 12, further comprising:
a controller, for configuring the parameter information required for the scheduling and shaping by the scheduling and shaping module.

14. The device according to claim 12, wherein the device is configured at an outlet end of the video source server or inlet end of an access device, or is built in the access device.

15. The device according to claim 12, wherein the scheduling and shaping module is used to classify the received TF, and each TF corresponds to a queue storing the descriptive information of the TF; the scheduling and shaping module is further used to schedule the TF queue according to the flow classification result, the shaping is respectively made within each of the flow classification queue, and the descriptive information of the scheduled and shaped TF is sent to the sending interface module.

16. The device according to claim 15, wherein the scheduling and shaping module schedules each flow classification queue in polling mode.

17. The device according to claim 12, wherein the TF comprises Ethernet frames or Asynchronous Transfer Mode (ATM) cells.

18. The device according to claim 12, wherein the TF descriptive information comprises at least one of the following: position information of the TF stored in a buffer, information of each field in the TF message, length information of the TF message, a destination Media Access Control (MAC) address of the TF message, a source MAC address of the TF message, a source IP address of the TF message and a destination IP address of the TF message.

19. The device according to claim 12, wherein the access device comprises a digital subscriber line access multiplexer (DSLAM) equipment.
